(19) United States
(12) Patent Application Publication
(10) Pub. No.: US 2003/0103273 A1
(43) Pub. Date: Jun. 5, 2003

(54) Optical Seal Comparator

(76) Inventor: Wen-Tsao Lee, Hsinchu (TW)

Correspondence Address: WEN-TSAO LEE, NO. 10-17, SHIAUFENLIN, DALIN TSUEN, BEI PU, HSINCHU, 314, TW

(21) Appl. No.: 09/683,208

(22) Filed: Dec. 2, 2001

(51) Int. Cl. G02B 27/14; G02B 17/00

(52) U.S. Cl. 359/726

(57) ABSTRACT

An optical seal comparator which uses the optic path formed by combination of splitter mirror with mirror, and other optic accessories, making comparison between pattern of compared seal and that of standard one by projection on the same optic plan, then through the overlapping process to achieve precise comparison. In order to speed up the process, the unit uses alternating electronic signals to control brightness of the two patterns, making display one after the other to pinpoint the inconsistent part from the overlap by showing flickered image.

### BACKGROUND OF INVENTION

This invention relates to an optical seal comparator with which uses the optic path formed by combination of splitter mirror, with mirror, and other optic accessories, making comparison between pattern of compared seal and that of standard one by projection on the same optic plan, then through the overlapping process to achieve precise comparison.

It is well known in the art that Seal pattern comparison has based on angle folding or keeping the original pattern on a transparent sheet then covers the chosen one for comparison. The process needs professional personnel with expertise and experiences to conduct the authentication and verification. However, these methods are only available for the comparison of same size of the seal, unavailable for analysis on the detailed trace. This is because the pattern on the top shields the one at the bottom, causing errors due to the unavailability of showing the two patterns on the same plan. Inevitably, this increases the uncertainty in document authentication process.

The concept of this invention is based upon the character of splitter mirror, making partial penetration and reflection of the image, with mirror to form an optic path. Through this optic path, the reference of the original seal pattern, and one pattern chosen for comparison, both illuminated by light, and their images are projected to a splitter mirror, respectively, at a 45-degree angle of incidence. By way of, splitter mirror set up in the optic path, operator can see through both the seal patterns, one image of pattern chosen for comparison, and one reference image of the original seal pattern, coming out of the splitter mirror. The phenomenon that two images within the equal optical distance to the splitter mirror, appear on the same optic plan is observable.

Because the reference image reflected from splitter mirror is going through a mirror reflection, it is needed to first have the image go through a mirror, making the formed an erect virtual image, after mirrored twice reflection. Adjustment on the corresponding position between seal pattern and the targeted one for comparison is done so that the two images are overlapped one on the other. If it is a perfect match, there will be only a sole image presented. If the two images are inconsistent, the targeted pattern is then interpreted as not from the original seal. This explains why the two overlapped images, though, presented in the same optic plane, can't form a sole image.

### SUMMARY OF INVENTION

In accordance with the present invention, there is provided a solution of seal comparison on optic plan, that vanishing parallax in two images of pattern, as a replace for conventional methods of angle folding and sheet covering. For complex pattern precise comparison, a set of magnifiers can be arranged in appropriate positions within the optic path. This is for the purpose to magnify two images for detailed trace investigation, meanwhile, make the images presented one on top of the other. Due to the visual residuary effect, flickered image is formed to pinpoint the difference in the overlapping area, therefore, the details on the discrepancy portion, how different it is, and where the difference is, are clearly presented. A fast approach in precise matching of seal patterns and detailed trace analysis is achieved. For personnel who perform seal pattern authentication, recognition, matching, and verification, this is a truly help for them.

The characteristics of this Invention can be specifically presented by the following detailed figures.

### BRIEF DESCRIPTION OF DRAWINGS

FIG. 1 is a schematic view showing an optical seal comparator according to the present invention.

FIG. 2 is a schematic view showing a multiple-order magnification structure.

FIG. 3 is a schematic view showing a close-up structure.

FIG. 4 is a schematic view showing an adjustable magnification structure.

FIG. 5 is a schematic block diagram of an image display switching control unit.

### DETAILED DESCRIPTION

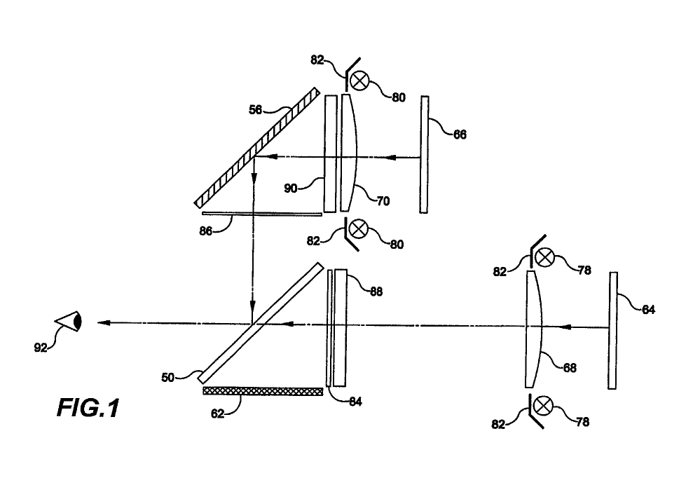

The detailed description of the preferred embodiments is as follows: As shown in FIG. 1, the image of first pattern 64 illuminated by first light source 78 and reflection plate 82, whose image then goes through first lens 68, first liquid crystal panel 88, first polarizer 84, and then to splitter mirror 50, is the same as the optical distance of second pattern 66 illuminated by second light source 80 and reflection plate 82, whose image then goes through second lens 70, second liquid crystal panel 90, to mirror 56, then being reflected from there goes through second polarizer 86, and then to splitter mirror 50.

Through splitter mirror 50 at an inclined angle of 45 degrees in the optic path, operator 92 is able to observe the image of second pattern 66 reflected off splitter mirror 50 as an erect virtual image after being mirrored twice, meanwhile, to see through splitter mirror 50 and observe both images of first pattern 64, second pattern 66 presented on the same optic plane. After having the two images overlapped one on top of the other by adjusting corresponding position between first pattern 64 and second pattern 66, if they are consistent, it is the same pattern from the same seal. If they are not, then it comes from a different seal.

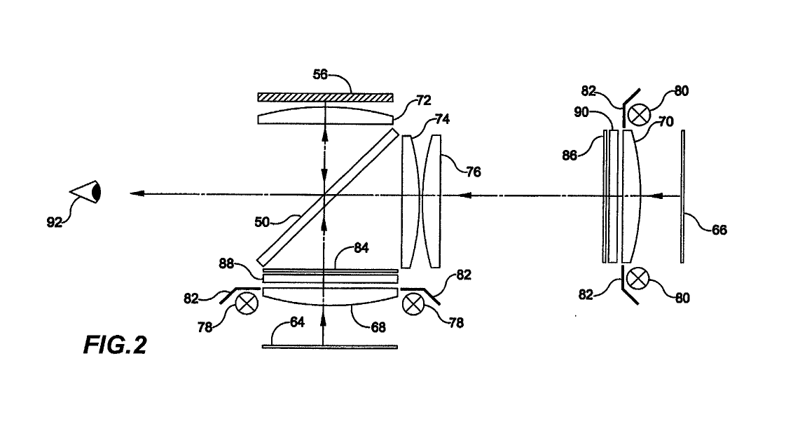

As shown in FIG. 2, the image of first pattern 64 illuminated by first light source 78 and reflection plate 82, whose image then goes through first lens 68, first liquid crystal panel 88, first polarizer 84, splitter mirror 50, third lens 72, to mirror 56, then being reflected from there to third lens 72, and then to splitter mirror 50, is the same as the optical distance of second pattern 66 illuminated by second light source 80 and reflection plate 82, whose image then goes through second lens 70, second liquid crystal panel 90, second polarizer 86, fifth lens 76, fourth lens 74, and then to splitter mirror 50.

Through splitter mirror 50 at an inclined angle of 45 degrees in the optic path, operator 92 is able to observe the image of first pattern 64, which has been reflected at splitter mirror 50, it is an erect virtual image mirrored twice and highly-powered magnified. Look at the perspective image of splitter mirror 50 at the same time, which shows the erect virtual image of second pattern 66 highly-powered magnified as well, both images appear in the same optic plane, adjusting the relative positions of first pattern 64 and second pattern 66 can overlap the two magnified images.

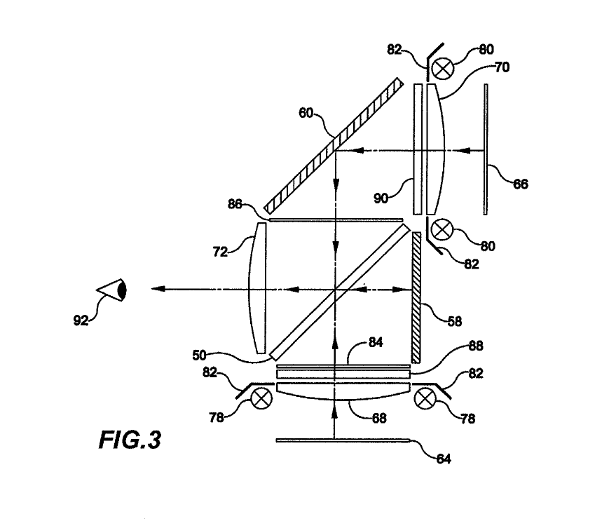

As shown in FIG. 3, the image of first pattern 64 illuminated by first light source 78 and reflection plate 82, whose image then goes through first lens 68, first liquid crystal panel 88, first polarizer 84, to splitter mirror 50, then being reflected from there to first mirror 58, and then being reflected back to splitter mirror 50, then to third lens 72, is the same as the optical distance of second pattern 66 illuminated by second light source 80 and reflection plate 82, whose image then goes through second lens 70, second liquid crystal panel 90, to second mirror 60, then being reflected from there to second polarizer 86, to splitter mirror 50, then being reflected from there to third lens 72.

Through splitter mirror 50 at an inclined angle of 45 degrees and third lens 72 in the optic path, operator 92 is able to observe the image of second pattern 66, which has been reflected at splitter mirror 50, it is an erect virtual image mirrored twice and highly-powered magnified. Look at the perspective image of splitter mirror 50 at the same time, which shows the erect virtual image of first pattern 64 highly-powered magnified and mirrored twice as well, both images appear in the same optic plane, adjusting the relative positions of first pattern 64 and second pattern 66 can overlap the two magnified images.

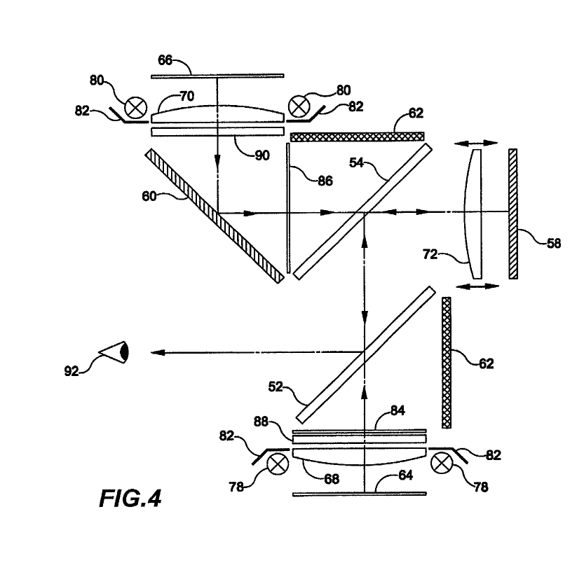

As shown in FIG. 4, the image of first pattern 64 illuminated by first light source 78 and reflection plate 82, whose image then goes through first lens 68, first liquid crystal panel 88, first polarizer 84, first splitter mirror 52, to second splitter mirror 54, then being reflected from there to third lens 72, to first mirror 58, and then being reflect back to third lens 72, to second splitter mirror 54, then being reflected from there to first splitter mirror 52, is the same as the optical distance of second pattern 66 illuminated by second light source 80 and reflection plate 82, whose image then goes through second lens 70, second liquid crystal panel 90, to second mirror 60, then being reflected from there goes through second polarizer 86, second splitter mirror 54, third lens 72, to first mirror 58 and being reflected back to third lens 72, to second splitter mirror 54, then being reflect from there to first splitter mirror 52.

Through splitter mirror 50 at an inclined angle of 45 degrees in the optic path, operator 92 is able to observe the images of first pattern 64 and second pattern 66, which has been reflected at first splitter mirror 52, both of them are magnified erect virtual images mirrored four times and appear in the same optic plane, adjusting the relative positions of first pattern 64 and second pattern 66 can overlap the two magnified images.

As far as the optic path is concerned, because the images of first pattern 64 and second pattern 66 go through the same optical distance, the focal length of first lens 68 and second lens 70 are the same, the optical distance between first pattern 64 and first lens 68 is same as the optical distance between second pattern 66 and second lens 70. Under those circumstances, there is the same as the ratio of magnification between the image of first pattern 64 magnified through passing first lens 68 with third lens 72 and the image of second pattern 66 magnified through passing second lens 70 with third lens 72. Therefore, third lens 72 or third lens 72 with first mirror 58 can be moved along the optic axis between first mirror 58 and second splitter mirror 54 to simultaneously increase the magnifying multiple of the images of first pattern 64 and second pattern 66.

In other words, the same magnifying multiple has magnified those two images.

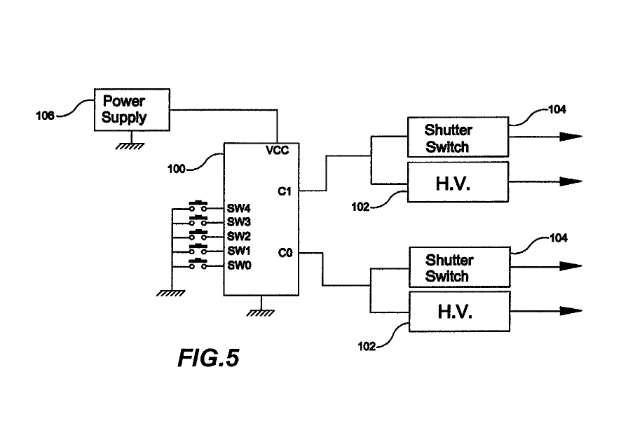

As shown in FIG. 5, an image display switching control unit provides to speed up the process of seal comparison, which uses alternating electronic signals to control brightness of the two patterns, making display one after the other to pinpoint the inconsistent part from the overlap by showing flickered image. The unit includes a micro controller 100, a dual high voltage circuit (H.V.) 102, a dual liquid crystal shutter switch circuit (shutter switch) 104 and a power supply, the detail as follow: 1. High voltage circuit (H.V.) 102—Receiving from control signal sent from micro controller 100, controls on/off status of high-voltage current, causing brightness/darkness of discharge tube of pattern light source.

2. Liquid crystal shutter switch circuit (shutter switch) 104—Receiving from control signal sent from micro controller 100, to activate the effect of polarization to control status of transparency or opaque of the liquid crystal panel with polarizer, dominating display of the image availability.

3. Power Supply 106—providing electric power for image display switching control unit.

4. Micro Controller 100—a programmable central processing unit with ROM burned in relevant code based on a specific purpose, making the output signal status is controlled by input settings. There are five different functionality settings at input available.

SW0 gives the option of still pattern display or dynamic alternating pattern SW1 gives the control of adjustment for fast dynamic motion display; SW2 gives the control of adjustment for slow dynamic motion display; SW3 only shows the image of the first pattern; SW4 only shows the image of the second pattern. Output dynamic signal is the alternating dynamic electronic signal provided by code-driven input.

The frequency spectrum is ranging from 1 Hz to 200 Hz, through input set up. The outputs are C0 and C1. C0 signal either goes to high voltage circuit 102 to control the discharge tube of the first light source, or to circuit of liquid crystal shutter switch 104 to control liquid crystal panel. C1 signal either goes to high voltage circuit 102 to control the discharge tube of the second light sources, or to liquid crystal shutter switch circuit 104 to control second liquid crystal panel 90, dynamically and alternatively displaying two different images by controlling the switch of liquid crystal panel for them or brightness/darkness of the lighting source of two patterns. Based on requests, above-mentioned output is selectable between high voltage circuit 102 and liquid crystal shutter switch circuit 104 whichever is appropriate.

The alternating display for the two patterns is through alternating electronic signal controlling on/off status of first light source 78 and second light source 80 alternatively, or both first light source 78 and second light source 80 are constant on, meanwhile, making on/off status of first liquid crystal panel 88 and second liquid crystal panel 90 opposite against each other. In the process of overlapping, the two images will be the same if there is neither inconsistency nor flickering within images presented. For any existing inconsistency, flickering phenomenon is presented. Operator 92 analyzes and magnifies details of these two images, quickly verifying if these images are of the same or different from each other, in the meantime, finding where the difference is and how different it is. In the optic path the direction of polarization between first polarizer 84 and second polarizer 86 is one against to the other in the optic path, ensuring independent presentation of each image and avoiding mutual interference, therefore, to enhance the quality of images during comparison by reinforcing the contrast of each image. Furthermore, this is to cooperate with effect by first liquid crystal panel 88 and second liquid crystal panel 90, making alternating image display by controlling status of transparency or opaque of the optic path that determines the availability of image display.

The light source for the patterns is determined by pattern format. Reflection light source is for opaque pattern, whereas, back-light is for transparent one. Reflection light source mainly relies on normal light bulbs. If fast transition between brightness and darkness is necessary, the reaction is sluggish. If equipped with liquid crystal panel and polarizer or switched to discharge lamp, then static and clear dynamic image is presented. Anti-reflection device 62 is a light absorber for avoiding reflected optical noise in the optic path.

It will be now apparent to those skilled in the art that other embodiments, detail and uses can be made consistent with the letter and spirit of the foregoing disclosure and within the scope of this patent, which is limited only by the following claims, construed in accordance with the patent law, including the doctrine of equivalents.

What is claimed is:

1. An optical seal comparator, comprising: a) a splitter mirror, which making partial penetration and reflection of image; b) a mirror, which making total reflection of image; c) a first light source, which illuminates first pattern for first image; and e) a second light source, which illuminates second pattern for second image.

2. An optical seal comparator in accordance with claim 1, wherein said first image goes to splitter mirror, is the same as the optical distance of second image goes to mirror, then being reflected to splitter mirror.

3. An optical seal comparator in accordance with claim 1, wherein said first image goes through splitter mirror to mirror, then being reflected to splitter mirror, is the same as the optical distance of second image goes to splitter mirror.

4. An optical seal comparator in accordance with claim 1, further comprising: a) a first lens which place between first pattern and splitter mirror; b) a second lens which place between second pattern and splitter mirror.

5. An optical seal comparator in accordance with claim 4, wherein said first image goes through first lens, then to splitter mirror, is the same as the optical distance of second image goes through second lens, to mirror, then being reflected to splitter mirror.

6. An optical seal comparator in accordance with claim 4, wherein said first image goes through first lens, splitter mirror, to mirror, then being reflected to splitter mirror, is the same as the optical distance of second image goes through second lens, then to splitter mirror.

7. An optical seal comparator in accordance with claim 4, furthermore comprising a third lens, a fourth lens, and a fifth lens, wherein said first image goes through first lens, splitter mirror, third lens, to mirror, then being reflected back to third lens, then to splitter mirror, is the same as the optical distance of second image goes through second lens, fifth lens, fourth lens, then to splitter mirror.

8. An optical seal comparator in accordance with claim 1, further comprising a second mirror, wherein said first image goes to splitter mirror, then being reflected to mirror, then being reflected back to splitter mirror, is the same as the optical distance of second image goes to second mirror, then being reflected to splitter mirror.

9. An optical seal comparator in accordance with claim 1, further comprising a first lens, a second lens and third lens, wherein said first image goes through first lens, to splitter mirror, then being reflected to mirror, then being reflected back to splitter mirror, then to third lens, is the same as the optical distance of second image goes through second lens, to second mirror, then being reflected to splitter mirror, then being reflected to third lens.

10. An optical seal comparator in accordance with claim 1, further comprising a second splitter mirror and a second mirror, wherein said first image goes through first splitter mirror, to second splitter mirror, then being reflected to mirror, then being reflect back to second splitter mirror, then being reflected to splitter mirror, is the same as the optical distance of second image goes to second mirror, then being reflected from there goes through second splitter mirror, to mirror then being reflected back to second splitter mirror, then being reflect to splitter mirror.

11. An optical seal comparator in accordance with claim 10, furthermore comprising a first lens, a second lens, and a third lens, wherein said first image goes through first lens, splitter mirror, to second splitter mirror, then being reflected from there goes through third lens, to mirror and then being reflect back to second splitter mirror, then being reflected to splitter mirror, is the same as the optical distance of second image goes through second lens, to second mirror, then being reflected from there goes through second splitter mirror, third lens, to mirror and being reflected back to second splitter mirror, then being reflect to splitter mirror.

12. An optical seal comparator in accordance with claim 11, wherein said third lens moves along the optic axis between mirror and second splitter mirror.

13. An optical seal comparator in accordance with claim 1, further comprising: a) a first liquid crystal panel with a polarizer, which place between first pattern and splitter mirror; b) a second liquid crystal panel and a polarizer, which place between second pattern and splitter mirror; c) an image display switching control unit, which having alternating electronic signal controlling on/off status of first liquid crystal panel and second liquid crystal panel alternatively

14. An optical seal comparator in accordance with claim 10, furthermore comprising: a) a first liquid crystal panel with a polarizer, which place between first pattern and first splitter mirror; b) a second liquid crystal panel and a polarizer, which place between second pattern and second splitter mirror; c) an image display switching control unit, which having alternating electronic signal controlling on/off status of first liquid crystal panel and second liquid crystal panel alternatively.

15. An optical seal comparator in accordance with claim 1, further comprising an image display switching control unit which having alternating electronic signal controlling on/off status of first light source and second light source alternatively.
